(19) United States
(12) Patent Application Publication
(10) Pub. No.: US 2018/0285262 A1
(43) Pub. Date: Oct. 4, 2018

(54) TECHNIQUES FOR SHARED VIRTUAL MEMORY ACCESS PROTECTION

(71) Applicant: INTEL CORPORATION, SANTA CLARA, CA (US)

(72) Inventors: ANNA TRIKALINOU, HILLSBORO, OR (US); RAJESH M. SANKARAN, PORTLAND, OR (US); STEPHEN JUNKINS, BEND, OR (US)

(73) Assignee: INTEL CORPORATION, SANTA CLARA, CA (US)

(21) Appl. No.: 15/476,918

(22) Filed: Mar. 31, 2017

(51) Int. Cl. G06F 12/084; G06F 12/14; G06F 12/1045; G06F 12/1036; G06F 12/109; G06F 12/1072; G06F 12/02

(52) U.S. Cl. CPC G06F 12/084; G06F 12/1475; G06F 12/1045; G06F 12/0284; G06F 12/109; G06F 12/1072; G06F 12/1036

(57) ABSTRACT

Various embodiments described herein include an input/output memory management unit (IOMMU) that can restrict write accesses originating from a shared virtual memory (SVM) device towards a CPU's code page, so that the SVM device cannot be used to attack and manipulate the CPU's behavior. In some embodiments, the IOMMU may perform a security check so that whenever a write request arrives from an SVM device, if the page requested is present and is executable, an access violation fault is generated and the request is terminated. In some such embodiments, this may prevent a malicious or vulnerable device from corrupting the CPU's process memory and causing an arbitrary code execution with the CPU process's privileges.

### BACKGROUND

Shared memory may refer to memory that can be simultaneously accessed by multiple programs or processes with an intent to provide communication among them or avoid redundant copies. Virtual memory may refer to a memory management technique that maps memory addresses used by a program or process, called virtual addresses, to physical addresses in computer memory. In various embodiments, translation to/from a virtual address from/to a physical address may occur transparently to the program or process. Typically, an operating system (OS) may manage the virtual address spaces and the assignment of physical memory to virtual memory.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a first logic flow.

FIG. 4 illustrates an embodiment of a second logic flow.

FIG. 5 illustrates an embodiment of a storage medium.

FIG. 6 illustrates an embodiment of a computing architecture.

FIG. 7 illustrates an embodiment of a communications architecture.

### DETAILED DESCRIPTION

Various embodiments are generally directed to techniques for shared virtual memory (SVM) access protection, such as by performing a security check whenever a write request arrives from an SVM device, for instance. Some embodiments are particularly directed to an input/output memory management unit (IOMMU) that prevents an SVM device from modifying a code page by generating an access request fault. In one embodiment, for example, an apparatus for memory access protection may comprise a memory and logic for an IOMMU, at least a portion of the logic implemented in circuitry coupled to the memory. In various embodiments, the logic may receive a memory access request from an SVM device and determine the memory access request includes a write request. In various such embodiments, the logic may identify a memory page associated with the memory access request and determine the memory page is present in main memory and executable. In some embodiments, the logic may generate an access request fault based on determining the memory access request includes a write request, the memory page associated with the memory access request is present in main memory, and the memory page associated with the memory access request is executable. These and other embodiments are described and claimed.

Some challenges facing IOMMUs include the inability to perform a security check to prevent an SVM device from modifying a code page. These challenges may result from an SVM device having implicit access to the entire process memory space. In some situations, these challenges may provide an attack vector for a malicious user. For instance, a malicious user may manipulate a workload of an SVM device to corrupt a central processing unit's (CPU's) process memory and hijack its control flow. Adding further complexity, many applications can choose the read, write, and execute permissions of their own memory pages. For instance, sometimes both write and execute permissions may be granted simultaneously, such as with Just-In-Time (JIT) code, packers, self-modifying code, and the kernel. These and other factors may result in an IOMMU with poor security and limited functionality. Such limitations can drastically reduce the usability and applicability of the IOMMU, contributing to ineffective systems with security vulnerabilities and limited capabilities.

Various embodiments described herein include an IOMMU that can restrict write accesses originating from an SVM device towards a CPU's code page, so that the SVM device cannot be used to attack and manipulate the CPU's behavior. In some embodiments, the IOMMU may perform a security check so that whenever a write request arrives from an SVM device, if the page requested is present and is executable, an access violation fault is generated and the request is terminated. In some such embodiments, this may prevent a malicious or vulnerable device from corrupting the CPU's process memory and causing an arbitrary code execution with the CPU process's privileges. In these and other ways the IOMMU may enable reliable and efficient security checks to achieve improved shared virtual memory access protection by SVM devices while reducing attack vectors for malicious users, resulting in several technical effects and advantages.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

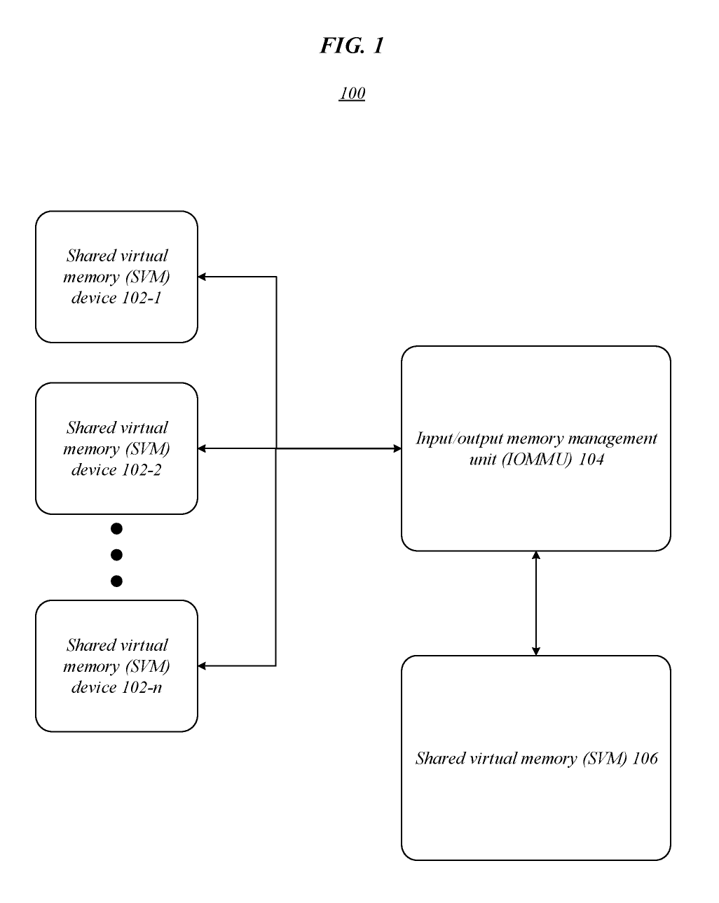

FIG. 1 illustrates an example of an operating environment 100 that may be representative of various embodiments. Operating environment 100 may include shared virtual memory (SVM) devices 102-1, 102-2, 102-n, input/output memory management unit (IOMMU) 104, and shared virtual memory (SVM) 106. In operating environment 100, IOMMU 104 may support memory operations between SVM devices 102-1, 102-2, 102-n and SVM 106. For example, IOMMU 104 may restrict write accesses originating from an SVM device (e.g., SVM device 102-1, 102-2, or 102-n) towards a CPU's code page, so that the SVM device cannot be used to attack and manipulate the CPU's behavior. The embodiments are not limited in this context.

In various embodiments, IOMMU 104 may facilitate and control memory operations between SVM devices 102-1, 102-2, 102-n and SVM 106. In various such embodiments, IOMMU 104 may be a memory management unit that connects a direct memory access (DMA) capable input/output (I/O) bus to the main memory. In some embodiments, main memory may be any memory that is directly accessible by a CPU. For instance, main memory may comprise random access memory (RAM). In various embodiments, main memory may be communicatively coupled with a CPU via a memory bus. In various such embodiments, IOMMU 104 may receive a memory access request before the memory access request passes through the memory bus. In other such embodiments, IOMMU 104 may receive a memory access request after the memory access request passes through the memory bus.

In some embodiments, IOMMU 104 may enable a CPU process to directly share resources of SVM 106 with a particular SVM device (e.g., SVM device 102-1, 102-2, or 102-n). From the software application's perspective, this may allow for seamless pointer-based data structure sharing, while from the system's perspective, it may allow for process memory page table sharing and device page faulting. However, by using SVM 106, the SVM device may have implicit access to an entire 64-bit process memory, and without IOMMU 104 performing a security check to restrict write accesses originating from an SVM device towards a CPU's code page, the SVM device may be used as a means to attack and manipulate the CPU's behavior. Accordingly, in one or more embodiments described herein, IOMMU 104 may perform a security check to determine one or more of whether a source of a memory access request is an SVM device, whether the memory access request is a write request, whether a memory page associated with the memory access request is present in main memory, and whether the memory page associated with the memory access is executable.

In some embodiments, when IOMMU 104 receives a memory access request for SVM 106, it may determine whether the source of the memory access request is an SVM device (e.g., SVM device 102-1, 102-2, or 102-n). In some such embodiments, when IOMMU 104 determines a memory access request was received from an SVM device, it may determine whether the memory access request is a write request. However, if the memory access request is not from an SVM device and/or is not a write request, IOMMU 104 may serve the memory access request by communicating data from/to SVM 106 to/from the source of the memory access request. For instance, when a memory access request comprising a read request is received from SVM device 102-2, IOMMU 104 may serve the read request by communicating data from SVM 106 to SVM device 102-2.

In various embodiments, when IOMMU 104 receives a memory access request from an SVM device that includes a write request, IOMMU 104 may identify a memory page in SVM 106 associated with the write request and determine whether the associated memory page is present and executable. In various such embodiments, when the memory page associated with the write request is present and executable, IOMMU 104 may generate an access violation fault, and the request may be terminated. However, if the memory page associated with the write request is not present and/or executable, IOMMU 104 may serve the write request. For example, when a write request is associated with a memory page in SVM 106 that is not executable, IOMMU 104 may serve the write request by communicating data from the requesting SVM device (e.g., SVM device 102-1, 102-2, or 102-n) to SVM 106 for storage.

In some embodiments, IOMMU 104 may map device-visible virtual addresses to physical addresses according to a paging architecture. In some such embodiments, IOMMU 104 may utilize one or more of a memory access request, a page table, a page directory, or a page-directory-pointer table supported by the paging architecture to translate a device-visible virtual address to a physical address, identify a memory page associated with a memory access request, determine whether the memory page associated with the memory access request is present in main memory, and/or determine whether the memory page associated with the memory access request is executable. For instance, SVM device 102-1 may send a memory access request to IOMMU 104 that includes a device-visible virtual address. IOMMU 104 may then identify or determine, based on the virtual address, one or more of a page-directory pointer, a page directory entry, a page table entry, a memory page, and a physical address associated with the memory access request.

In various embodiments, the paging architecture may support one or more informational bits in one or more of the page directory entries, the page table entries, the memory page, the physical addresses, or elsewhere. In various such embodiments, the informational bits may be used by IOMMU 104 to determine one or more characteristics of the memory access request, such as whether the memory page associated with the memory access request is present and/or executable. For instance, a page table entry associated with a memory access request may include informational bits used by IOMMU 104 to determine whether the memory page associated with a memory access request is present and whether the memory page associated with the memory access request is executable. In one or more embodiments, the paging architecture may support physical address extension (PAE).

In some embodiments, a paging architecture may be used that supports an informational bit to indicate whether a memory page is present in main memory. In some such embodiments, this informational bit may be referred to as a present bit. In various embodiments, IOMMU 104 may determine whether a memory page associated with a memory access request is present in main memory based on the present bit. For example, a memory page associated with a memory access request may be present in main memory if the present bit is 1 and not present in main memory if the present bit is 0. In various embodiments, the present bit may be a PAE bit. In some embodiments, a present bit may be part of each page table entry. In some such embodiments, the present bit may be the least significant bit of each page table entry.

In various embodiments, a paging architecture may be used that supports an informational bit to indicate whether a memory page is executable. In various such embodiments, this informational bit may be referred to as an execution bit. In some embodiments, the execution bit may segregate areas of memory for use as either storage of processor instructions (executable code) or for storage of data. In other words, the execution bit may define whether the associated memory page can be used by a CPU to execute code from. In various embodiments, the execution bit may be used by IOMMU 104 to determine whether a memory page associated with a memory access request is executable (i.e., whether the memory page is used for storage of processor instructions). For example, a memory page associated with a memory access request may be executable if the execution bit is 0 and not executable if the execution bit is 1. In some embodiments, the execution bit may be a PAE bit. In various embodiments, an execution bit may be part of each page table entry. In various such embodiments, the execution bit may be the most significant bit of each page table entry. In some embodiments, the execution bit may include a No-eXecute (NX) bit of Intel® 64 and Intel® Architecture (IA) 32 paging architectures. In some such embodiments, IOMMU 104 may determine whether a memory page associated with a memory access request is executable based on the NX bit.

As shown in the illustrated embodiment, IOMMU 104 may be communicatively coupled with SVM devices 102-1, 102-2, 102-n and SVM 106. It will be appreciated that any number of SVM devices may be included in various embodiments, as indicated by the 102-n notation. Thus, embodiments described herein may include one or more SVM devices. In some embodiments, an SVM device may include any device or component that utilizes shared virtual memory to enable a CPU process to directly share resources with the device or component. For instance, a CPU and an SVM device may share resources via a unified virtual address space. In various embodiments, an SVM device may include one or more of a hardware accelerator, a graphics processing unit (GPU), a field programmable gate array (FPGA), a system on chip (SOC), a speech processing unit (SPU), an input/output (I/O) device, a digital signal processor (DSP), an application-specific integrated circuit (ASIC), or the like.

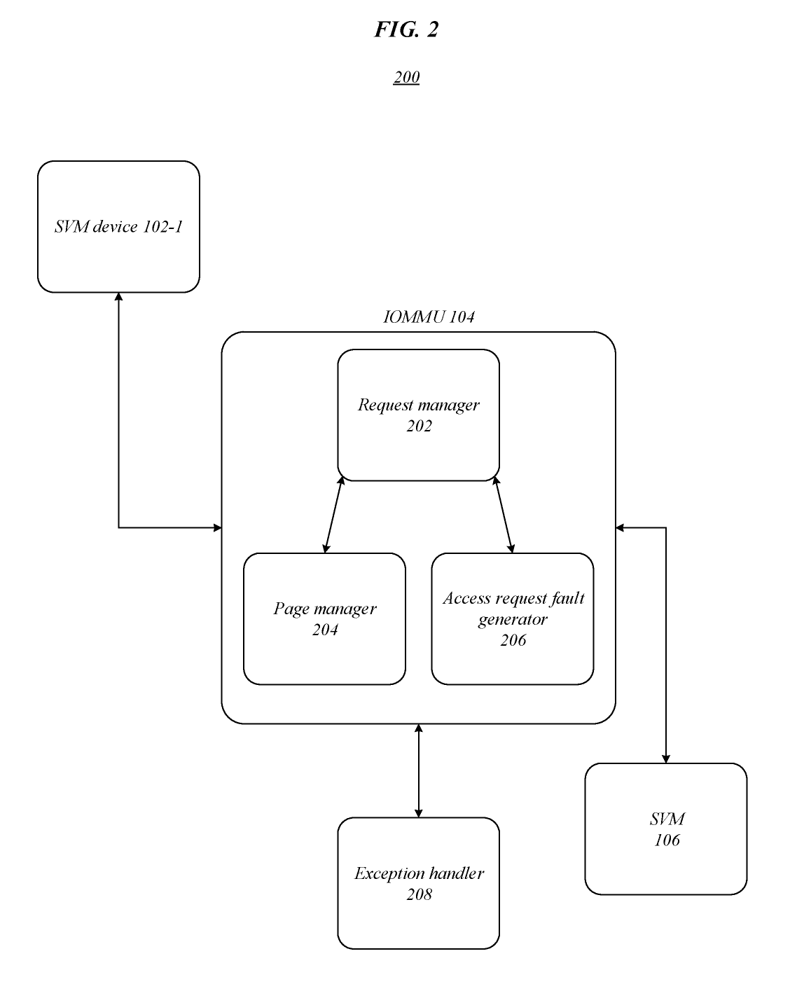

FIG. 2 illustrates an example of an operating environment 200 that may be representative of various embodiments. Operating environment 200 may include exception handler 208 in addition to SVM device 102-1, IOMMU 104, and SVM 106. In operating environment 200, IOMMU 104 may perform a security check to determine whether to service a memory access request received from SVM device 102-1. In various embodiments, the security check may determine one or more of whether a source of a memory access request is an SVM device, whether the memory access request is a write request, and whether a memory page associated with a memory access request is present in main memory and executable. In various such embodiments, IOMMU 104 may determine the memory access request passes the security check and service the memory access request unless the source of the memory access request is an SVM device, the memory access request is a write request, and the memory page associated with the memory access request is present in main memory and executable. On the other hand, if IOMMU 104 determines the memory access request does not pass the security check and should not be serviced, an access request fault may be generated and passed to exception handler 208. The embodiments are not limited in this context.

In the illustrated embodiments, IOMMU 104 may include request manager 202, page manager 204, and access request fault generator 206. In some embodiments, the components of IOMMU 104 may operate to determine how to handle memory access requests received from SVM device 102-1. For example, the components of IOMMU 104 may operate to restrict memory access requests that include write requests originating from SVM device 102-1 towards a CPU's code page, so that SVM device 102-1 cannot be used to attack and manipulate the CPU's behavior. It will be appreciated that while the IOMMU 104 embodiment illustrated in FIG. 2 includes request manager 202, page manager 204, and access request fault generator 206 components, any type, number, or combination of components may be utilized to realize the functionality of IOMMU 104 described herein.

In various embodiments, when IOMMU 104 receives a memory access request, request manager 202 may determine the source of the memory access request. For example, request manager 202 may determine SVM device 102-1 was the source of the memory access request. In some embodiments, when the source of the memory access request is not an SVM device (e.g., SVM device 102-1), request manager 202 may determine the memory access request passes the security check.

In some embodiments, if request manager 202 determines the source of the memory access request is an SVM device and the memory access request includes a write request, page manager 204 may be utilized to identify a memory page associated with the memory access request. In various embodiments, page manager 204 may utilize one or more of the memory access request, a page table, a page directory, or a page-directory-pointer table to identify the memory page associated with the memory access request. Once the memory page associated with the memory access request is identified, page manager 204 may determine whether the memory page is present in main memory and whether the memory page is executable.

In various embodiments, page manager 204 may determine whether the memory page associated with the memory access request is present and/or executable based on one or more informational bits discussed above. For instance, page manager 204 may identify a page table entry associated with the memory access request. In such instances, page manager 204 may determine whether the memory page associated with the memory access request is present based on a first bit in the page table entry and whether the memory page associated with the memory access request is executable based on a second bit in the page table entry. In some embodiments, page manager 204 may pass an indication of whether the memory page associated with the memory access request is present in main memory and/or executable to request manager 202.

In various embodiments, based on the determination of whether the memory page associated with the memory access request is present in main memory and executable, request manager 202 may determine whether the memory access request passes the security check. For example, if the memory page associated with the memory access request is either not present in main memory or is not executable, request manager 202 may determine the memory access request passes the security check. However, if the memory page associated with the memory access request is present in main memory and is executable, request manager 202 may cause access request fault generator 206 to generate an access request fault. In various embodiments, the access request fault may then be passed to exception handler 208. In various such embodiments, exception handler 208 may terminate the memory access request in response to the access request fault. In some embodiments, exception handler 208 may be part of an operating system (OS).

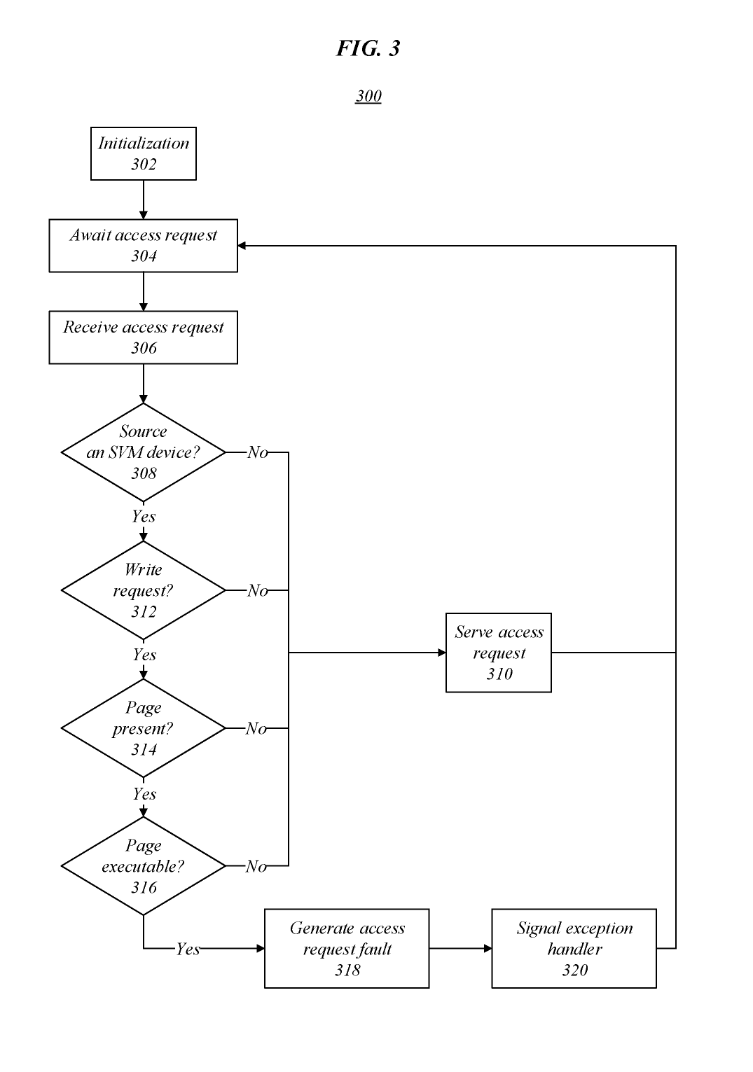

FIG. 3 illustrates one embodiment of a logic flow 300, which may be representative of operations that may be executed in various embodiments in conjunctions with providing shared virtual memory (SVM) access protection. The logic flow 300 may be representative of some or all of the operations that may be executed by one or more components of operating environments 100 or 200 of FIGS. 1-2, such as IOMMU 104. The embodiments are not limited in this context.

In the illustrated embodiment shown in FIG. 3, the logic flow 300 may begin at block 302. At block 302 “initialization” the IOMMU may be initialized. For example, the initialization may be part of a Basic Input/output System (BIOS) boot up process. In some embodiments, the initialization may include the BIOS boot up process, as well as additional functionality that the BIOS needs to do to enable the security check, such as setting up a page table, a page directory, a page-directory-pointer, an informational bit, or the like. In various embodiments, initialization may prepare IOMMU 104 to monitor a memory path between SVM devices 102-1, 102-2, 102-n and SVM 106.

Proceeding to block 304 “await access request” receipt of a memory access request may be awaited. In various embodiments, monitoring the memory path between SVM devices and a shared virtual memory may include waiting for receipt of a memory access request. For example, IOMMU 104 may await receipt of a memory access request by monitoring the memory path between SVM devices 102-1, 102-2, 102-n and SVM 106. In some embodiments, block 304 may be the first block in a continuous loop in which a device sends an access request to memory through IOMMU 104.

At block 306 “receive access request” an access request may be received. For example, IOMMU 104 may receive a memory access request from SVM device 102-1, 102-2, or 102-n. In various embodiments, the access request may be targeted at reading or writing data to or from SVM 106. In some embodiments, request manager 202 may receive the memory access request from SVM device 102-1.

Continuing to block 308 “source an SVM device?”, it may be determined if the source of the received memory access request is an SVM device. For example, IOMMU 104 may determine if the source of a memory access request is SVM device 102-1, 102-2, or 102-n or a non-SVM device. In some embodiments, request manager 202 may determine the source of a memory access request. In various embodiments, the source of a memory access request may be determined based on one or more bits in the memory access request. For instance, the memory access request may include a unique identifier that is used by IOMMU 104 to determine the source of the memory access request.

Referring back to block 308, if the source is not an SVM device, then logic flow 300 may proceed to block 310 “serve access request”. For instance, IOMMU 104 may read or write content to or from SVM 106 in response to the source of the memory access request not being an SVM device (e.g., not SVM device 102-1, 102-2, or 102-n). In some embodiments, when the source of a memory access request is not an SVM device, IOMMU 104 may determine the memory access request passes the security check. In various embodiments serving the access request may proceed as it would in legacy systems. In some embodiments, once the memory access request has been served, logic flow 300 may return to block 304 “await access request” as part of a continuous loop. In some such embodiments, the continuous loop may only be exited upon a power state change or a system settings change.

In some embodiments, serving the memory access request may include utilizing IOMMU 104 (e.g., page manager 204) to map a device-visible virtual address included in the memory access request to a corresponding physical address according to the paging architecture. In some such embodiments, IOMMU 104 may utilize one or more of the memory access request, a page table, a page directory, or a page-directory-pointer table to translate a device-visible virtual address to a physical address and/or identify a memory page associated with a memory access request. For instance, SVM device 102-1 may send a memory access request to IOMMU 104 that includes a device-visible virtual address. IOMMU 104 may then identify or determine one or more of a page-directory pointer, a page directory entry, a page table entry, a memory page, and a physical address associated with the memory access request based on the virtual address. In various embodiments, IOMMU 104 may retrieve and/or store data in SVM 106 as part of serving the memory access request.

Referring again to block 308, if the source is an SVM device, the logic flow 300 may proceed to block 312 “write request?”. For instance, IOMMU 104 may determine whether the memory access request from SVM 102-1 includes a write request. In various embodiments, request manager 202 may determine whether the memory access request is a write request. In some embodiments, when the memory access request is not a write request, IOMMU 104 (e.g., request manager 202) may determine the memory access request passes the security check. In various embodiments, when a memory access request is not a write request, logic flow 300 may proceed to block 310 “serve access request” and continue as described above. However, if the memory access request is a write request, logic flow 300 may proceed to block 314.

At block 314 “Page present?” it may be determined whether a memory page associated with the memory access request is present in main memory. For example, IOMMU 104 may utilize page manager 204 to determine whether a memory page associated with a memory access request is present in main memory. In various embodiments, main memory may refer to random access memory (RAM). In some embodiments, IOMMU 104 may utilize one or more of a memory access request, a page table, a page directory, or a page-directory-pointer table supported by the paging architecture to determine whether the memory page associated with the memory access request is present in main memory. In various embodiments, a paging architecture may be used that supports an informational bit (e.g., present bit) to indicate whether a memory page is present in main memory. For example, a memory page associated with a memory access request may be present in main memory if the present bit is 1 and not present in main memory if the present bit is 0. In some embodiments, a present bit may be part of each page table entry. In some such embodiments, the present bit may be the least significant bit of each page table entry. In various embodiments, the present bit may be a PAE bit.

Referring back to block 314, if the page is not present, logic flow 300 may proceed to block 310 “serve access request” and continue as described above. In some embodiments, when the memory page associated with a memory access request is not present in main memory, block 310 may include paging the memory page associated with the memory access request into main memory. In various embodiments, when a memory page associated with a memory access request is not present in main memory, IOMMU 104 may determine the memory access request passes the security check. On the other hand, if the memory page associated with the memory access request is present in main memory, logic flow 300 may proceed to block 316.

At block 316 “page executable” it may be determined whether the memory page associated with a memory access request is executable. For example, IOMMU 104 may utilize page manager 204 to determine whether a memory page associated with a memory access request is executable. In various embodiments, IOMMU 104 may utilize one or more of a memory access request, a page table, a page directory, or a page-directory-pointer table supported by the paging architecture to determine whether the memory page associated with the memory access request is executable. In some embodiments, a paging architecture may be used that supports an informational bit (e.g., execution bit) to indicate whether a memory page is executable. In various embodiments, the execution bit may define whether the associated memory page can be used by a CPU to execute code from.

In some embodiments, the execution bit may be used by IOMMU 104 to determine whether a memory page associated with a memory access request is executable (i.e., whether the memory page is used for storage of processor instructions). For example, a memory page associated with a memory access request may be executable if the execution bit is 0 and not executable if the execution bit is 1. In various embodiments, the execution bit may be a PAE bit. In some embodiments, an execution bit may be part of each page table entry. In various such embodiments, the execution bit may be the most significant bit of each page table entry. In some embodiments, the execution bit may include a No-eXecute (NX) bit of Intel® 64 and IA-32 paging architecture.

Referring back to block 316, if the page is not executable, logic flow 300 may proceed to block 310 “serve access request” and continue as described above. In various embodiments, when a memory page associated with a memory access request is not executable, IOMMU 104 may determine the memory access request passes the security check. On the other hand, if the memory page associated with the memory access request is executable, logic flow 300 may proceed to block 318.

At block 318 “generate access request fault” an access request fault may be generated. For example, IOMMU 104 may generate an access request fault when at block 308 the source is identified as an SVM device (e.g., SVM device 102-1, 102-2, 102-n), at block 312 the memory access request is determined to include a write request, at block 314 the memory page associated with the memory access request is present in main memory, and at block 316 the memory page associated with the memory access request is executable. In various embodiments, generation of the access request fault may be in response to IOMMU 104 determining the memory access request does not pass the security check. In some embodiments, request manager 202 may signal access request fault generator 206 to produce the access request fault.

Proceeding to block 320 “signal exception handle” an exception handler may be made aware of the access request fault. For example, IOMMU 104 (e.g., access request fault generator 206) may generate an access request fault that includes an interrupt signal to make exception handler 208 aware of the access request fault. In some embodiments, exception handler 208 may be part of an OS. In various embodiments, exception handler 208 may terminate the memory access request in response to the access request fault. In some embodiments, once the exception handler has been signaled of the access request fault, logic flow 300 may return to block 304 “await access request” as part of a continuous loop.

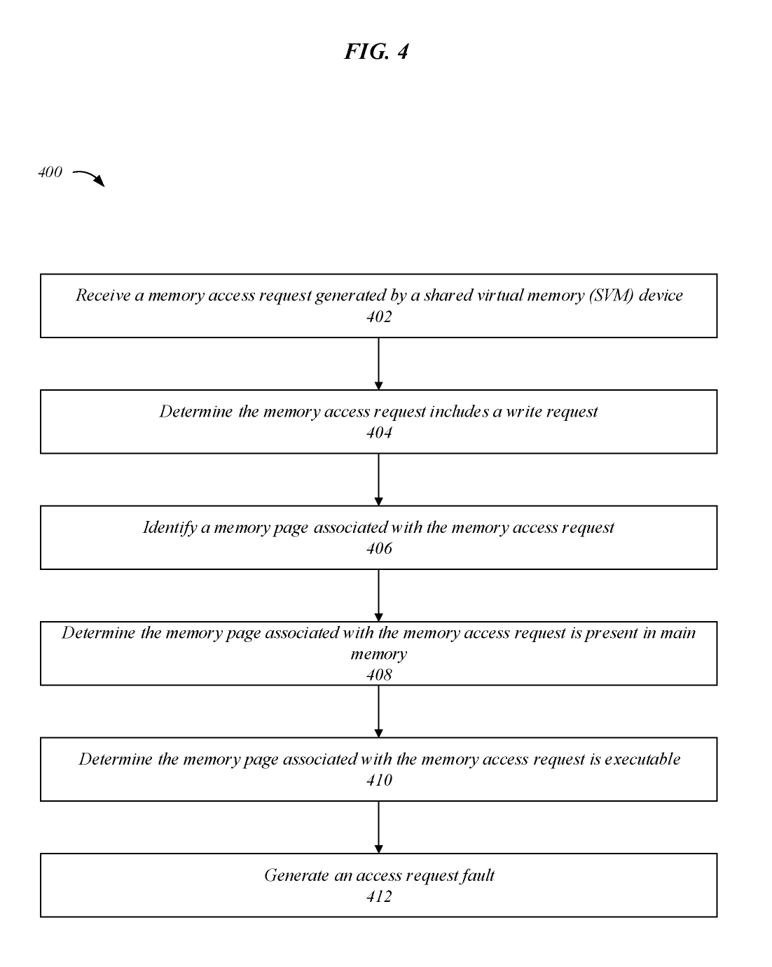

FIG. 4 illustrates one embodiment of a logic flow 400, which may be representative of operations that may be executed in various embodiments in conjunctions with providing shared virtual memory (SVM) access protection. The logic flow 400 may be representative of some or all of the operations that may be executed by one or more components of operating environments 100 or 200 of FIGS. 1-2, such as IOMMU 104. The embodiments are not limited in this context.

In the illustrated embodiment shown in FIG. 4, the logic flow 400 may begin at block 402. At block 402 “receive a memory access request generated by a shared virtual memory (SVM) device” a memory access request generated by an SVM device may be received. For example, IOMMU 104 may receive a memory access request from SVM device 102-1. In some embodiments, request manager 202 may determine the memory access request was generated by an SVM device. Continuing to block 404 “determine the memory access request includes a write request” it may be determined that a write request is included in the memory access request. For instance, IOMMU 104 may utilize request manager 202 to determine whether the memory access request includes a write request.

Proceeding to block 406 “identify a memory page associated with the memory access request” a memory page associated with the memory access request may be identified. For instance, IOMMU 104 may utilize page manager 204 to identify a memory page in SVM 106 that is associated with the memory access request. In some embodiments, IOMMU 104 (e.g., page manager 204) may utilize one or more of the memory access request, a page table, a page directory, or a page-directory-pointer table supported by the paging architecture to identify the memory page associated with a memory access request.

At block 408 “determine the memory page associated with the memory access request is present in main memory” it may be determined that the memory page associated with the memory access request is present in main memory. For example, IOMMU 104 (e.g., page manager 204) may determine the memory page associated with the memory access request is present based on an informational bit. In some embodiments, the informational bit may be included in a page table entry associated with the memory access request.

Continuing to block 410 “determine the memory page associated with the memory access request is executable” it may be determined that the memory page associated with the memory access request is executable. For instance, IOMMU 104 (e.g., page manager 204) may determine the memory page associated with the memory access request is executable based on an informational bit. In various embodiments, the informational bit may be included in a page table entry associated with the memory access request.

Proceeding to block 412 “generate an access request fault” an access request fault may be generated. For example, IOMMU 104 (e.g., access request fault generator 206) may generate an access request fault in response to the memory access request being generated by an SVM device (e.g., SVM device 102-1, 102-2, or 102-n), the memory access request including a write request, and the memory page associated with the memory access request being present in main memory and executable. In various embodiments, this may prevent a malicious or vulnerable SVM device from corrupting the CPU's process memory and causing an arbitrary code execution with the CPU process's privileges.

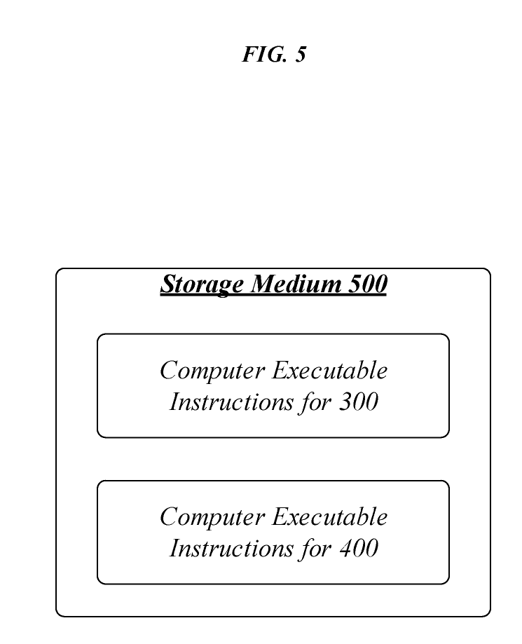

FIG. 5 illustrates an embodiment of a storage medium 500. Storage medium 500 may comprise any non-transitory computer-readable storage medium or machine-readable storage medium, such as an optical, magnetic or semiconductor storage medium. In various embodiments, storage medium 500 may comprise an article of manufacture. In some embodiments, storage medium 500 may store computer-executable instructions, such as computer-executable instructions to implement one or more of logic flows or operations described herein, such as with respect to logic flow 300 of FIG. 3 and logic flow 400 of FIG. 4. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

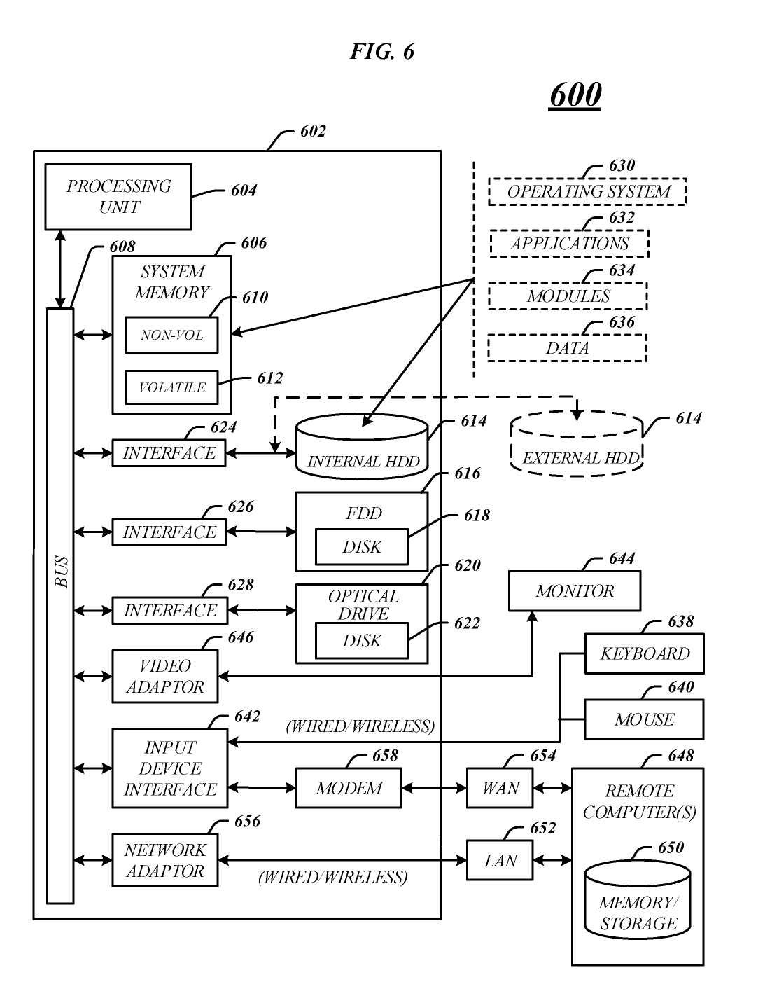

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, the computing architecture 600 may be representative, for example, of a computer system that implements or utilizes one or more components of operating environment 100 of FIG. 1 and/or operating environment 200 of FIG. 2. In some embodiments, computing architecture 600 may be representative, for example, of one or more portions of IOMMU 104 that implement or utilize one or more embodiments described herein. For instance, IOMMU 104 may be a GPU operating in conjunction with computing architecture 600. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. In some embodiments, system memory 606 may include main memory. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and Institute of Electrical and Electronics Engineers (IEEE) 994 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of IOMMU 104, such as one or more portions of request manager 202, page manager 204, and/or access request fault generator 206.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. In various embodiments, one or more migrations may occur via the networked environment. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 1358, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

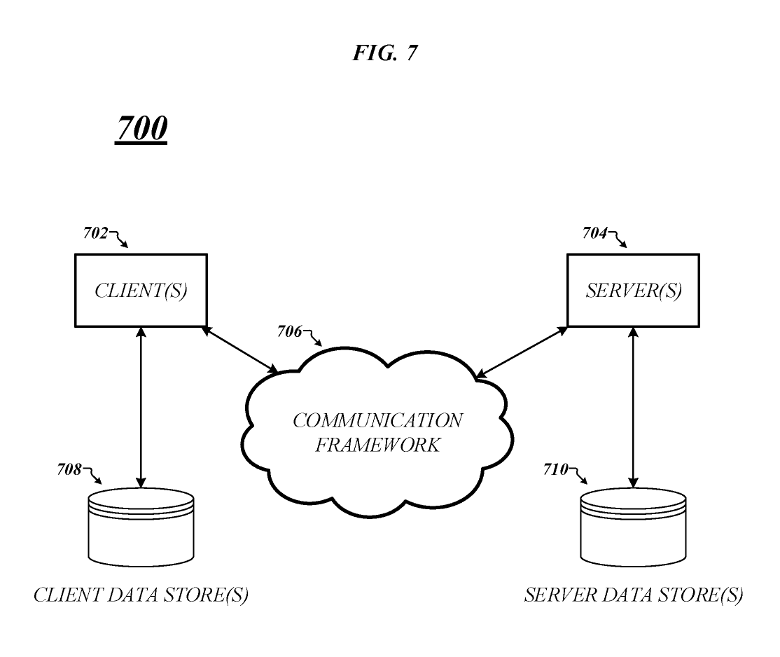

FIG. 7 illustrates a block diagram of an exemplary communications architecture 700 suitable for implementing various embodiments as previously described, such as virtual machine migration. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein, and storage medium 500 of FIG. 5 in conjunction with storage of data received from any one of clients 702 on any of server data stores 710.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus for memory access protection, the apparatus comprising: a memory; and logic for an input/output memory management unit (IOMMU), at least a portion of the logic implemented in circuitry coupled to the memory, the logic to: receive a memory access request from a shared virtual memory (SVM) device; determine the memory access request includes a write request; identify a memory page associated with the memory access request; determine the memory page associated with the memory access request is present in main memory; determine the memory page associated with the memory access request is executable; and generate an access request fault.

Example 2 includes the subject matter of Example 1, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 3 includes the subject matter of Example 1, the logic to identify a page table entry of a plurality of page table entries in a page table based on one or more of the memory access request, a page-directory-pointer table, or a page directory.

Example 4 includes the subject matter of Example 3, the logic to identify the memory page associated with the memory access request based on the page table entry.

Example 5 includes the subject matter of Example 4, the logic to determine the memory page associated with the memory access request is present in main memory based on a bit of the page table entry in the page table.

Example 6 includes the subject matter of Example 5, the bit comprising a least significant bit of the page table entry in the page table.

Example 7 includes the subject matter of Example 5, the bit comprising a physical address extension (PAE) bit.

Example 8 includes the subject matter of Example 4, the logic to determine the memory page associated with the memory access request is executable based on a bit of the page table entry in the page table.

Example 9 includes the subject matter of Example 8, the bit comprising a no-execute (NX) bit.

Example 10 includes the subject matter of Example 8, the bit comprising a most significant bit of the page table entry in the page table.

Example 11 includes the subject matter of Example 8, the bit comprising a physical address extension (PAE) bit.

Example 12 includes the subject matter of Example 1, the memory access request comprising a direct memory access (DMA) with a virtual address.

Example 13 includes the subject matter of Example 12, the logic to: determine a linear address based on the virtual address; identify a page table entry of a plurality of page table entries in a page table based on the linear address; and identify a memory page associated with the memory access request based on the page table entry.

Example 14 includes the subject matter of Example 1, the logic to signal an exception handler of the access request fault.

Example 15 includes the subject matter of Example 14, the exception handler comprised in an operating system (OS), the exception handler to terminate the memory access request.

Example 16 includes the subject matter of Example 1, the main memory comprising random access memory (RAM).

Example 17 includes the subject matter of Example 1, at least a portion of the circuitry coupled to the memory to implement the portion of the logic comprising a central processing unit (CPU), the CPU and the SVM device to share a unified virtual address space.

Example 18 is a system, comprising: an input/output memory management unit (IOMMU) comprising logic, at least of portion of which is implemented in circuitry, the logic to: receive a memory access request from a shared virtual memory (SVM) device; determine the memory access request includes a write request; identify a memory page associated with the memory access request; determine the memory page associated with the memory access request is present in main memory; determine the memory page associated with the memory access request is executable; generate an access request fault; and an operating system (OS) executing on a central processing unit (CPU), the OS comprising an exception handler, the exception handler to receive the access request fault and terminate the memory access request based on the access request fault.

Example 19 includes the subject matter of Example 18, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 20 includes the subject matter of Example 18, the logic to identify a page table entry of a plurality of page table entries in a page table based on one or more of the memory access request, a page-directory-pointer table, or a page directory.

Example 21 includes the subject matter of Example 20, the logic to identify the memory page associated with the memory access request based on the page table entry.

Example 22 includes the subject matter of Example 21, the logic to determine the memory page associated with the memory access request is present in main memory based on a bit of the page table entry in the page table.

Example 23 includes the subject matter of Example 22, the bit comprising a least significant bit of the page table entry in the page table.

Example 24 includes the subject matter of Example 22, the bit comprising a physical address extension (PAE) bit.

Example 25 includes the subject matter of Example 21, the logic to determine the memory page associated with the memory access request is executable based on a bit of the page table entry in the page table.

Example 26 includes the subject matter of Example 25, the bit comprising a no-execute (NX) bit.

Example 27 includes the subject matter of Example 25, the bit comprising a most significant bit of the page table entry in the page table.

Example 28 includes the subject matter of Example 25, the bit comprising a physical address extension (PAE) bit.

Example 29 includes the subject matter of Example 18, the memory access request comprising a direct memory access (DMA) with a virtual address.

Example 30 includes the subject matter of Example 29, the logic to: determine a linear address based on the virtual address; identify a page table entry of a plurality of page table entries in a page table based on the linear address; and identify a memory page associated with the memory access request based on the page table entry.

Example 31 includes the subject matter of Example 18, the logic to signal the exception handler of the access request fault with an interrupt.

Example 32 includes the subject matter of Example 18, the SVM device to share a virtual address space the OS.

Example 33 includes the subject matter of Example 18, the main memory comprising random access memory (RAM).

Example 34 is a computer-implemented method comprising: receiving a memory access request from a shared virtual memory (SVM) device; determining the memory access request includes a write request; identifying a memory page associated with the memory access request; determining the memory page associated with the memory access request is present in main memory; determining the memory page associated with the memory access request is executable; and generating an access request fault.

Example 35 includes the subject matter of Example 34, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 36 includes the subject matter of Example 34, comprising identifying a page table entry of a plurality of page table entries in a page table based on one or more of the memory access request, a page-directory-pointer table, or a page directory.

Example 37 includes the subject matter of Example 36, comprising identifying the memory page associated with the memory access request based on the page table entry.

Example 38 includes the subject matter of Example 37, comprising determining the memory page associated with the memory access request is present in main memory based on a bit of the page table entry in the page table.

Example 39 includes the subject matter of Example 38, the bit comprising a least significant bit of the page table entry in the page table.

Example 40 includes the subject matter of Example 38, the bit comprising a physical address extension (PAE) bit.

Example 41 includes the subject matter of Example 37, comprising determining the memory page associated with the memory access request is executable based on a bit of the page table entry in the page table.

Example 42 includes the subject matter of Example 41, the bit comprising a no-execute (NX) bit.

Example 43 includes the subject matter of Example 41, the bit comprising a most significant bit of the page table entry in the page table.

Example 44 includes the subject matter of Example 41, the bit comprising a physical address extension (PAE) bit.

Example 45 includes the subject matter of Example 34, the memory access request comprising a direct memory access (DMA) with a virtual address.

Example 46 includes the subject matter of Example 45, comprising: determining a linear address based on the virtual address; identifying a page table entry of a plurality of page table entries in a page table based on the linear address; and identifying a memory page associated with the memory access request based on the page table entry.

Example 47 includes the subject matter of Example 34, comprising signaling an exception handler of the access request fault.

Example 48 includes the subject matter of Example 47, the exception handler comprised in an operating system (OS), the exception handler to terminate the memory access request.

Example 49 includes the subject matter of Example 34, the main memory comprising random access memory (RAM).

Example 50 is at least one non-transitory computer-readable medium comprising a set of instructions that, in response to being executed at an encryption device, cause the encryption device to: receive a memory access request from a shared virtual memory (SVM) device; determine the memory access request includes a write request; identify a memory page associated with the memory access request; determine the memory page associated with the memory access request is present in main memory; determine the memory page associated with the memory access request is executable; and generate an access request fault.

Example 51 includes the subject matter of Example 50, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 52 includes the subject matter of Example 50, comprising instructions that, in response to being executed at the encryption device, cause the encryption device to identify a page table entry of a plurality of page table entries in a page table based on one or more of the memory access request, a page-directory-pointer table, or a page directory.

Example 53 includes the subject matter of Example 52, comprising instructions that, in response to being executed at the encryption device, cause the encryption device to identify the memory page associated with the memory access request based on the page table entry.

Example 54 includes the subject matter of Example 53, comprising instructions that, in response to being executed at the encryption device, cause the encryption device to determine the memory page associated with the memory access request is present in main memory based on a bit of the page table entry in the page table.

Example 55 includes the subject matter of Example 54, the bit comprising a least significant bit of the page table entry in the page table.

Example 56 includes the subject matter of Example 54, the bit comprising a physical address extension (PAE) bit.

Example 57 includes the subject matter of Example 53, comprising instructions that, in response to being executed at the encryption device, cause the encryption device to determine the memory page associated with the memory access request is executable based on a bit of the page table entry in the page table.

Example 58 includes the subject matter of Example 57, the bit comprising a no-execute (NX) bit.

Example 59 includes the subject matter of Example 57, the bit comprising a most significant bit of the page table entry in the page table.

Example 60 includes the subject matter of Example 57, the bit comprising a physical address extension (PAE) bit.

Example 61 includes the subject matter of Example 50, the memory access request comprising a direct memory access (DMA) with a virtual address.

Example 62 includes the subject matter of Example 61, comprising instructions that, in response to being executed at the encryption device, cause the encryption device to: determine a linear address based on the virtual address; identify a page table entry of a plurality of page table entries in a page table based on the linear address; and identify a memory page associated with the memory access request based on the page table entry.

Example 63 includes the subject matter of Example 50, comprising instructions that, in response to being executed at the encryption device, cause the encryption device to signal an exception handler of the access request fault.

Example 64 includes the subject matter of Example 63, the exception handler comprised in an operating system (OS), the exception handler to terminate the memory access request.

Example 65 includes the subject matter of Example 50, the main memory comprising random access memory (RAM).

Example 66 is an apparatus for memory access protection, the apparatus comprising: means for receiving a memory access request from a shared virtual memory (SVM) device; means for determining the memory access request includes a write request; means for identifying a memory page associated with the memory access request; means for determining the memory page associated with the memory access request is present in main memory; means for determining the memory page associated with the memory access request is executable; and means for generating an access request fault.

Example 67 includes the subject matter of Example 66, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

Example 68 includes the subject matter of Example 66, comprising means for identifying a page table entry of a plurality of page table entries in a page table based on one or more of the memory access request, a page-directory-pointer table, or a page directory.

Example 69 includes the subject matter of Example 68, comprising means for identifying the memory page associated with the memory access request based on the page table entry.

Example 70 includes the subject matter of Example 69, comprising means for determining the memory page associated with the memory access request is present in main memory based on a bit of the page table entry in the page table.

Example 71 includes the subject matter of Example 70, the bit comprising a least significant bit of the page table entry in the page table.

Example 72 includes the subject matter of Example 70, the bit comprising a physical address extension (PAE) bit.

Example 73 includes the subject matter of Example 69, comprising means for determining the memory page associated with the memory access request is executable based on a bit of the page table entry in the page table.

Example 74 includes the subject matter of Example 73, the bit comprising a no-execute (NX) bit.

Example 75 includes the subject matter of Example 73, the bit comprising a most significant bit of the page table entry in the page table.

Example 76 includes the subject matter of Example 73, the bit comprising a physical address extension (PAE) bit.

Example 77 includes the subject matter of Example 66, the memory access request comprising a direct memory access (DMA) with a virtual address.

Example 78 includes the subject matter of Example 77, comprising: means for determining a linear address based on the virtual address; means for identifying a page table entry of a plurality of page table entries in a page table based on the linear address; and means for identifying a memory page associated with the memory access request based on the page table entry.

Example 79 includes the subject matter of Example 66, comprising means for signaling an exception handler of the access request fault.

Example 80 includes the subject matter of Example 79, the exception handler comprised in an operating system (OS), the exception handler to terminate the memory access request.

Example 81 includes the subject matter of Example 66, the main memory comprising random access memory (RAM).

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
a memory; and
logic for an input/output memory management unit (IOMMU), at least a portion of the logic implemented in circuitry coupled to the memory, the logic to:
receive a memory access request from a shared virtual memory (SVM) device;
determine the memory access request includes a write request;
identify a memory page associated with the memory access request;
determine the memory page associated with the memory access request is present in main memory;
determine the memory page associated with the memory access request is executable; and
generate an access request fault.

2. The apparatus of claim 1, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

3. The apparatus of claim 1, the logic to identify a page table entry of a plurality of page table entries in a page table based on one or more of the memory access request, a page-directory-pointer table, or a page directory.

4. The apparatus of claim 3, the logic to identify the memory page associated with the memory access request based on the page table entry.

5. The apparatus of claim 4, the logic to determine the memory page associated with the memory access request is present in main memory based on a bit of the page table entry in the page table.

6. The apparatus of claim 5, the bit comprising a least significant bit of the page table entry in the page table.

7. The apparatus of claim 4, the logic to determine the memory page associated with the memory access request is executable based on a bit of the page table entry in the page table.

8. The apparatus of claim 7, the bit comprising a no-execute (NX) bit.

9. The apparatus of claim 7, the bit comprising a most significant bit of the page table entry in the page table.

10. The apparatus of claim 1, the memory access request comprising a direct memory access (DMA) with a virtual address.

11. The apparatus of claim 10, the logic to:
determine a linear address based on the virtual address;
identify a page table entry of a plurality of page table entries in a page table based on the linear address; and
identify the memory page associated with the memory access request based on the page table entry.

12. The apparatus of claim 1, the logic to signal an exception handler of the access request fault.

13. The apparatus of claim 12, the exception handler comprised in an operating system (OS), the exception handler to terminate the memory access request.

14. A computer-implemented method comprising:
receiving a memory access request from a shared virtual memory (SVM) device;
determining the memory access request includes a write request;
identifying a memory page associated with the memory access request;
determining the memory page associated with the memory access request is present in main memory;
determining the memory page associated with the memory access request is executable; and
generating an access request fault.

15. The computer-implemented method of claim 14, comprising identifying a page table entry of a plurality of page table entries in a page table based on one or more of the memory access request, a page-directory-pointer table, or a page directory.

16. The computer-implemented method of claim 15, comprising identifying the memory page associated with the memory access request based on the page table entry.

17. The computer-implemented method of claim 16, comprising determining the memory page associated with the memory access request is present in main memory based on a bit of the page table entry in the page table.

18. The computer-implemented method of claim 15, comprising determining the memory page associated with the memory access request is executable based on a bit of the page table entry in the page table.

19. The computer-implemented method of claim 18, the bit comprising a no-execute (NX) bit.

20. At least one non-transitory computer-readable medium comprising a set of instructions that, in response to being executed by a processor circuit, cause the processor circuit to:
receive a memory access request from a shared virtual memory (SVM) device;
determine the memory access request includes a write request;
identify a memory page associated with the memory access request;
determine the memory page associated with the memory access request is present in main memory;
determine the memory page associated with the memory access request is executable; and
generate an access request fault.

21. The at least one non-transitory computer-readable medium of claim 20, the SVM device comprising one or more of a hardware accelerator, a graphics processing unit (GPU), a field programmable gate array (FPGA), a system on chip (SOC), a speech processing unit (SPU), an input/output (I/O) device, a digital signal processor (DSP), or an application-specific integrated circuit (ASIC).

22. The at least one non-transitory computer-readable medium of claim 20, comprising instructions that, in response to being executed by a processor circuit, cause the processor circuit to identify a page table entry of a plurality of page table entries in a page table based on one or more of the memory access request, a page-directory-pointer table, or a page directory.

23. The at least one non-transitory computer-readable medium of claim 22, comprising instructions that, in response to being executed by a processor circuit, cause the processor circuit to identify the memory page associated with the memory access request based on the page table entry.

24. The at least one non-transitory computer-readable medium of claim 23, comprising instructions that, in response to being executed by a processor circuit, cause the processor circuit to determine the memory page associated with the memory access request is present in main memory based on a bit of the page table entry in the page table.

25. The at least one non-transitory computer-readable medium of claim 22, comprising instructions that, in response to being executed by a processor circuit, cause the processor circuit to determine the memory page associated with the memory access request is executable based on a bit of the page table entry in the page table.
